(19) United States
(12) Patent Application Publication
(10) Pub. No.: US 2025/0197205 A1
(43) Pub. Date: Jun. 19, 2025

(54) APPARATUS FOR PRODUCING HYDROGEN GAS FROM AMMONIA USING LASER

(71) Applicant: Korea Photonics Technology Institute, Gwangju (KR)

(72) Inventors: Swook HANN, Gwangju (KR); Hyungsik JANG, Gwangju (KR)

(73) Assignee: Korea Photonics Technology Institute, Gwangju (KR)

(21) Appl. No.: 18/884,618

(22) Filed: Sep. 13, 2024

(30) Foreign Application Priority Data
Dec. 18, 2023 (KR) 10-2023-0184099

(51) Int. Cl. C01B 3/04

(52) U.S. Cl. CPC C01B 3/047; C01B 2203/0272; C01B 2203/0855

(57) ABSTRACT

Disclosed is an apparatus for producing hydrogen gas from ammonia gas using a laser. A decomposition device for decomposing ammonia gas in order to produce hydrogen gas includes an ammonia inlet provided at an uppermost end of the decomposition device to allow ammonia gas to easily flow into the decomposition device, a hydrogen outlet configured to discharge the hydrogen gas produced by decomposition of the ammonia gas, and a nitrogen outlet configured to discharge nitrogen gas produced by the decomposition of the ammonia gas. Laser light in a preset first wavelength band is incident from an outside to a contact point of the ammonia inlet, the hydrogen outlet, and the nitrogen outlet, so that the ammonia gas is decomposed.

### CROSS-REFERENCE TO RELATED APPLICATION

The present application claims priority under 35 U.S.C. § 119 (a) to Korean Patent Application No. 10-2023-0184099, filed in the Korean Intellectual Property Office on Dec. 18, 2023, the entire disclosure of which is incorporated herein by reference.

This patent is the results of research that was carried out by the support (a unique project number: 1415183774, a detailed project number: P0021547, a project name: The development of a quasi-continuous kW-class thulium-doped fiber laser for medical and agricultural applications of the Korea Institute for Advancement of Technology by the finances of the government of the Republic of Korea (The Ministry of Trade, Industry and Energy).

### BACKGROUND

### 1. Technical Field

The present disclosure relates to an apparatus for producing hydrogen gas from ammonia gas using a laser.

### 2. Related Art

Contents described in this part merely provide background information of the present embodiment, and do not constitute a conventional technology.

Hydrogen is in the spotlight as a clean energy source and is used in various industrial fields. Hydrogen is used in fuel cell vehicles, power generation fields, various industrial processes, and the like.

Currently, main methods for producing hydrogen include fossil fuel-based reforming processes, electrolysis methods, biological methods, and the like.

The fossil fuel-based reforming processes are suitable for large-scale hydrogen production, but have the problem of emitting a large amount of greenhouse gas such as carbon dioxide.

The electrolysis methods are clean, but require a significant amount of expensive electrical energy and have relatively low energy efficiency.

The biological methods are environmentally friendly, but technical and economic challenges exist in scaling the biological methods up to commercial scale.

This requires a hydrogen gas production method that is environmentally friendly and cost-effective.

### SUMMARY

Embodiments of the present disclosure are directed to providing a hydrogen production apparatus for producing hydrogen gas from ammonia gas using a laser.

According to an aspect of the present disclosure, a decomposition device for decomposing ammonia gas in order to produce hydrogen gas includes: an ammonia inlet provided at an uppermost end of the decomposition device to allow ammonia gas to easily flow into the decomposition device; a hydrogen outlet configured to discharge the hydrogen gas produced by decomposition of the ammonia gas; and a nitrogen outlet configured to discharge nitrogen gas produced by the decomposition of the ammonia gas, wherein laser light in a preset first wavelength band is incident from an outside to a contact point of the ammonia inlet, the hydrogen outlet, and the nitrogen outlet, so that the ammonia gas is decomposed.

According to an aspect of the present disclosure, the decomposition device is implemented in a lying ‘T’ shape.

According to an aspect of the present disclosure, the decomposition device is implemented of a material that allows the laser light to pass therethrough.

According to an aspect of the present disclosure, the preset first wavelength band is 1512 nm to 1532 nm.

According to an aspect of the present disclosure, a hydrogen production apparatus for producing hydrogen gas by decomposing ammonia gas includes: the decomposition device; and a light source configured to emit laser light in a preset first wavelength band to the decomposition device.

According to an aspect of the present disclosure, the light source emits laser light to a contact point of the ammonia inlet, the hydrogen outlet, and the nitrogen outlet.

According to an aspect of the present disclosure, the light source directly emits laser light to the ammonia gas.

According to an aspect of the present disclosure, a decomposition device for decomposing ammonia gas in order to produce hydrogen gas includes: an ammonia inlet provided at an uppermost end of the decomposition device to allow ammonia gas to easily flow into the decomposition device; a hydrogen outlet configured to discharge the hydrogen gas produced by decomposition of the ammonia gas; and a nitrogen outlet configured to discharge nitrogen gas produced by the decomposition of the ammonia gas, wherein the ammonia inlet has a curved shape from an inlet point of the ammonia gas to a contact point of the ammonia inlet, the hydrogen outlet, and the nitrogen outlet.

According to an aspect of the present disclosure, the ammonia inlet is implemented in a zigzag shape.

According to an aspect of the present disclosure, the ammonia inlet is implemented with a preset component.

According to an aspect of the present disclosure, the preset component generates heat of a predetermined temperature or higher when exposed to laser light in a preset wavelength band.

According to an aspect of the present disclosure, the preset component is a Nd: YAG (Yttrium Aluminum Garnet) or Yb: YAG component.

According to an aspect of the present disclosure, the preset component generates heat of 450° C. or higher when exposed to laser light in a wavelength band of 400 nm to 500 nm or 700 nm to 990 nm.

According to an aspect of the present disclosure, a hydrogen production apparatus for producing hydrogen gas by decomposing ammonia gas includes: the decomposition device; and a light source configured to emit laser light in a preset second wavelength band to an ammonia inlet within the decomposition device.

As described above, an aspect of the present disclosure has advantages of being environmentally friendly and efficient in terms of cost and size by producing hydrogen gas from ammonia gas using a laser.

### BRIEF DESCRIPTION OF THE DRAWINGS

FIG. 1 is a diagram illustrating a configuration of a hydrogen production apparatus according to a first embodiment of the present disclosure.

FIG. 2 is a diagram illustrating a configuration of a decomposition unit according to the first embodiment of the present disclosure.

FIG. 3 is a diagram illustrating a configuration of a hydrogen production apparatus according to a second embodiment of the present disclosure.

FIG. 4 is a diagram illustrating a configuration of a decomposition unit according to the second embodiment of the present disclosure.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part described in this specification or a combination of them, and should be understood that it does not exclude the possibility of the existence or addition of one or more other characteristics, numbers, steps, operations, components, parts, or combinations of them in advance.

All terms used herein, including technical or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

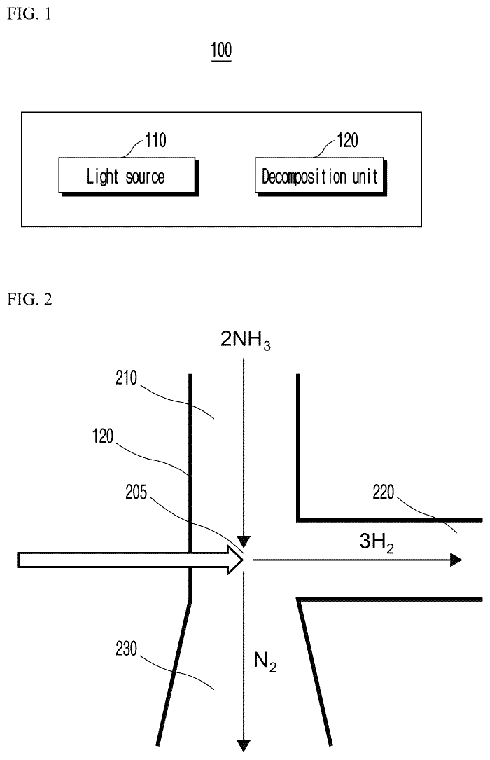

FIG. 1 is a diagram illustrating a configuration of a hydrogen production apparatus 100 according to a first embodiment of the present disclosure.

Referring to FIG. 1, the hydrogen production apparatus 100 according to the first embodiment of the present disclosure includes a light source 110 and a decomposition unit 120.

The hydrogen production apparatus 100 produces hydrogen gas from ammonia gas. Since the hydrogen production apparatus 100 requires the ammonia gas in producing the hydrogen gas, once the ammonia gas is prepared, the hydrogen production apparatus 100 can perform the hydrogen production at any time. The hydrogen gas is gas that is relatively very difficult to store or move. Accordingly, there was considerable inconvenience in directly moving the hydrogen gas to places requiring the hydrogen gas and storing the hydrogen gas therein. On the other hand, the ammonia gas is gas that is relatively very easy to store or move. Accordingly, the hydrogen production apparatus 100 produces the hydrogen gas from the ammonia gas that is easy to store, and thus can easily supply the hydrogen gas to places requiring the hydrogen gas. In particular, since the hydrogen production apparatus 100 produces the hydrogen gas from the ammonia gas using laser light, all problems of the hydrogen production method in the related art can be solved.

The hydrogen production apparatus 100 can emit laser light into the ammonia gas and decompose the ammonia gas into hydrogen gas by using the laser light directly. Alternatively, the hydrogen production apparatus 100 can generate heat by emitting the laser light to a tube through which the ammonia gas flows, and decompose the ammonia gas into the hydrogen gas by using the temperature of the tube through which the ammonia gas flows.

The light source 110 emits laser light in a preset first wavelength band in order to decompose the ammonia gas. The light source 110 emits the laser light to a part of the decomposition unit 120 and directly emits the laser light into the ammonia gas. In such a case, the light source 110 emits the laser light in a preset first wavelength band that is a wavelength band absorbed by the ammonia gas. The preset first wavelength band may be 1512 nm to 1532 nm. The ammonia gas absorbs the laser light in the wavelength band and its temperature rises rapidly, so that the ammonia gas is decomposed into nitrogen and hydrogen as follows.

2NH₃→N₂+3H₂

The light source 110 emits the laser light in the preset first wavelength band to the decomposition unit 120 so that the above-described decomposition occurs.

The light source 110 can be implemented with a diode light source. As the light source 110 is implemented with the diode light source, its size can be reduced, thereby reducing the overall size of the apparatus. In addition, since the diode light source has a fast response speed over 10,000° C. per second, a reaction (heat generation or decomposition) can be completed within several tens of ms.

The decomposition unit 120 receives the ammonia gas for producing the hydrogen gas and decomposes the ammonia gas into nitrogen gas and hydrogen gas. The decomposition unit 120 has the configuration illustrated in FIG. 2.

FIG. 2 is a diagram illustrating the configuration of the decomposition unit 120 according to the first embodiment of the present disclosure.

Referring to FIG. 2, the decomposition unit 120 according to the first embodiment of the present disclosure includes an ammonia inlet 210, a hydrogen outlet 220, and a nitrogen outlet 230.

The decomposition unit 120 is implemented in a lying (rotated 90°) ‘T’ shape and includes the ammonia inlet 210, the hydrogen outlet 220, and the nitrogen outlet 230. The ammonia inlet 210 is provided at the uppermost end of the decomposition unit 120 to allow the ammonia gas to easily flow into the decomposition unit 120.

A housing of the decomposition unit 120 may be implemented of a material that allows laser light to pass therethrough. Accordingly, the laser light can be incident into the decomposition unit 120 to decompose the ammonia gas.

The laser light (in a preset first wavelength band) emitted from the light source 110 is incident at a contact point 205 of the ammonia inlet 210, the hydrogen outlet 220, and the nitrogen outlet 230 of the decomposition unit 120. The laser light is incident into the corresponding point 205, and the ammonia flowing into the ammonia inlet 210 is decomposed into nitrogen gas and hydrogen gas by the laser light.

The relatively light hydrogen gas is (separated) discharged through the hydrogen outlet 220 implemented at the upper end, and the relatively heavy nitrogen gas is (separated) discharged through the nitrogen outlet 230 implemented at the lower end.

In such a case, the nitrogen outlet 230 may have a tapered structure in which a gap increases as a distance from the contact point 205 increases. As the nitrogen outlet 230 has such a structure, it is possible to minimize a phenomenon in which hydrogen discharged through the hydrogen outlet 220 flows back in the opposite direction (of the direction in which hydrogen is discharged) due to the pressure difference.

The hydrogen production apparatus 100 can easily produce the hydrogen gas from the ammonia gas using the laser light in the preset first wavelength band.

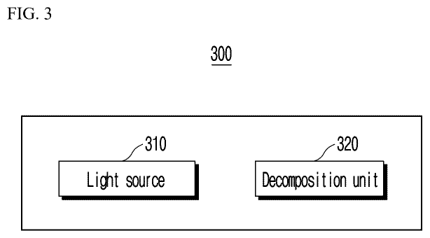

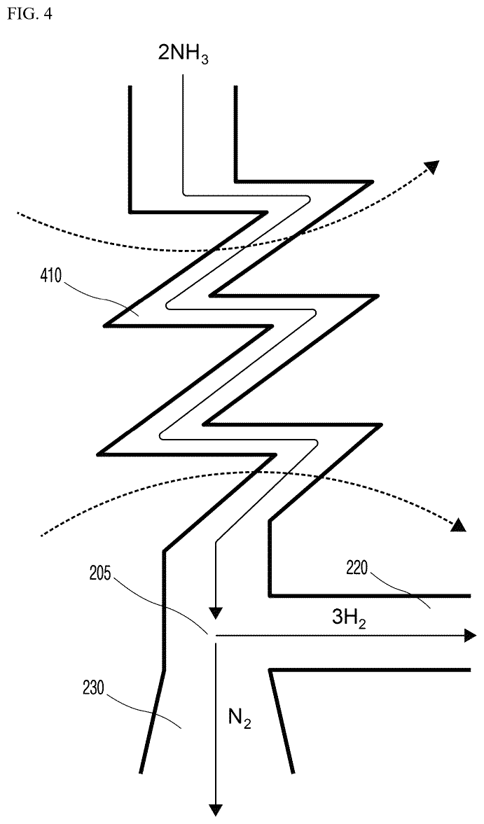

FIG. 3 is a diagram illustrating a configuration of a hydrogen production apparatus 300 according to a second embodiment of the present disclosure.

Referring to FIG. 3, the hydrogen production apparatus 300 according to the second embodiment of the present disclosure includes a light source 310 and a decomposition unit 320.

The light source 310 also emits laser light to the decomposition unit 320 in order to decompose ammonia gas. However, the light source 310 emits the laser light in a preset second wavelength band to the decomposition unit 320. The light source 310 does not directly emit the laser light for decomposition purposes to the ammonia gas like the light source 110, but emits, to a housing of the decomposition unit 320, light for increasing the temperature of the housing of the decomposition unit 320 and indirectly decomposing the ammonia gas. As described above, the ammonia gas has the property of being decomposed when irradiated with (laser) light in the preset first wavelength band. In addition, the ammonia gas has the property of being decomposed when exposed to a temperature of 450° C. to 600° C. under the pressure condition of 6 bar to 9 bar.

The light source 310 emits the laser light in the preset second wavelength band to the decomposition unit 320 in order to decompose the ammonia gas by using the latter condition. The preset second wavelength band is a wavelength band in which the decomposition unit 320 generates heat when exposed to light, and may be 400 nm to 500 nm or 700 nm to 990 nm.

Since the light source 310 is also implemented with a diode light source, its size can be reduced and its response speed can be improved.

The decomposition unit 320 receives the ammonia gas for producing hydrogen gas and decomposes the ammonia gas into nitrogen gas and hydrogen gas. The decomposition unit 320 has the configuration illustrated in FIG. 4.

FIG. 4 is a diagram illustrating the configuration of the decomposition unit 320 according to the second embodiment of the present disclosure.

Referring to FIG. 4, the decomposition unit 320 according to the second embodiment of the present disclosure includes a hydrogen outlet 220, a nitrogen outlet 230, and an ammonia inlet 410.

The decomposition unit 320 is basically implemented in a lying (rotated 90°) ‘T’ shape and includes the hydrogen outlet 220, the nitrogen outlet 230, and the ammonia inlet 410.

The decomposition unit 320 has a pressure of 6 bar to 9 bar that allows the ammonia gas to be decomposed, and may include the ammonia inlet 410 to thermally decompose the ammonia gas.

The ammonia inlet 410 is implemented at the uppermost end of the decomposition unit 320 to allow the ammonia gas to easily flow into the decomposition unit 320. However, unlike the ammonia inlet 210, the ammonia inlet 410 is implemented with a preset component, and has a curved shape such as a zigzag shape from the inlet point of the ammonia gas to a contact point 205 of the components 220, 230, and 410.

The ammonia inlet 410, more specifically, the inflow point of the ammonia gas to the contact point 205 of the components are implemented with the preset component. The preset component may be a Nd:YAG (Yttrium Aluminum Garnet) or Yb:YAG component. The preset component has the property of generating heat of 450° C. or higher when exposed to laser light in a wavelength band of 700 nm to 850 nm. The ammonia inlet 410 is implemented with the preset component, and the light source 310 emits the laser light in the preset second wavelength band to all parts of the ammonia inlet 410. As the ammonia inlet 410 is implemented with the preset component, it generates heat of 450° C. or higher when exposed to the laser light in the preset second wavelength band. Accordingly, the ammonia gas passing through the ammonia inlet 410 is exposed to heat of 450° C. or higher, which is a temperature at which the ammonia gas can be decomposed under the pressure condition of 6 bar to 9 bar. Accordingly, the ammonia gas may be decomposed while passing through the ammonia inlet 410.

On the other hand, the ammonia inlet 410 has a curved shape. As the ammonia inlet 410 has a curved shape, the speed of the ammonia gas passing through the ammonia inlet 410 is reduced, causing the ammonia gas to be exposed to heat of 450° C. or higher for a longer period of time. At the same time, a larger area of the ammonia inlet 410 may be heated by being exposed to the laser light in the preset second wavelength band.

The hydrogen gas and the nitrogen gas produced when the ammonia gas is decomposed are discharged through the hydrogen outlet 220 and the nitrogen outlet 230, respectively.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A decomposition device for decomposing ammonia gas in order to produce hydrogen gas, the decomposition device comprising:
an ammonia inlet provided at an uppermost end of the decomposition device to allow ammonia gas to easily flow into the decomposition device;
a hydrogen outlet configured to discharge the hydrogen gas produced by decomposition of the ammonia gas; and
a nitrogen outlet configured to discharge nitrogen gas produced by the decomposition of the ammonia gas,
wherein laser light in a preset first wavelength band is incident from an outside to a contact point of the ammonia inlet, the hydrogen outlet, and the nitrogen outlet, so that the ammonia gas is decomposed.

2. The decomposition device of claim 1, wherein the decomposition device is implemented in a lying ‘T’ shape.

3. The decomposition device of claim 1, wherein the decomposition device is implemented of a material that allows the laser light to pass therethrough.

4. The decomposition device of claim 1, wherein the preset first wavelength band is 1512 nm to 1532 nm.

5. A decomposition device for decomposing ammonia gas in order to produce hydrogen gas, the decomposition device comprising:
an ammonia inlet provided at an uppermost end of the decomposition device to allow ammonia gas to easily flow into the decomposition device;
a hydrogen outlet configured to discharge the hydrogen gas produced by decomposition of the ammonia gas; and
a nitrogen outlet configured to discharge nitrogen gas produced by the decomposition of the ammonia gas,
wherein the ammonia inlet has a curved shape from an inlet point of the ammonia gas to a contact point of the ammonia inlet, the hydrogen outlet, and the nitrogen outlet.

6. The decomposition device of claim 5, wherein the ammonia inlet is implemented in a zigzag shape.

7. The decomposition device of claim 5, wherein the ammonia inlet is implemented with a preset component.

8. The decomposition device of claim 7, wherein the preset component generates heat of a predetermined temperature or higher when exposed to laser light in a preset wavelength band.

9. The decomposition device of claim 8, wherein the preset component is a Nd:YAG (Yttrium Aluminum Garnet) or Yb:YAG component.

10. The decomposition device of claim 7, wherein the preset component generates heat of 450° C. or higher when exposed to laser light in a wavelength band of 400 nm to 500 nm or 700 nm to 990 nm.

11. A hydrogen production apparatus for producing hydrogen gas by decomposing ammonia gas, comprising:
the decomposition device of claim 1; and
a light source configured to emit laser light in a preset wavelength band to an ammonia inlet within the decomposition device.
